(19) United States
(12) Patent Application Publication
(10) Pub. No.: US 2010/0087344 A1
(43) Pub. Date: Apr. 8, 2010

(54) GREASE COMPOSITION AND MACHINE PART

(75) Inventor: Osamu Saita, Fujisawa-shi (JP)

Correspondence Address: NIXON & VANDERHYE, PC, 901 NORTH GLEBE ROAD, 11TH FLOOR, ARLINGTON, VA, 22203, US

(73) Assignee: KYODO YUSHI CO., LTD., KANAGAWA (JP)

(21) Appl. No.: 12/532,911

(22) PCT Filed: Mar. 26, 2008
(86) PCT No.: PCT/JP2008/055684

§ 371 Date: Sep. 24, 2009

(30) Foreign Application Priority Data
Mar. 26, 2007 (JP) 2007-079101

(51) Int. Cl. F16C 33/66; C10M 141/10

(52) U.S. Cl. 508/100; 508/438

(57) ABSTRACT

A grease composition which has an excellent anti-fretting property and general versatility, and a machine part which uses the same are provided. A grease composition comprising a urea thickener, a base oil, a phosphorothioate compound and an amine compound and a machine part which uses the same are provided.

### TECHNICAL FIELD

The present invention relates to a grease composition, and particularly, to a grease composition which has an excellent anti-fretting property and to a machine part which uses the same.

### BACKGROUND ART

In many cases, automobiles, electrical appliances and variety of machine parts and products are transported by rail or trucks. When they are being transported, fretting occurs on lubrication components coated with a grease due to vibrations resulting from rail joints or rough roads. Fretting is a surface damage which occurs under small amplitude vibrations and generates oxidized wear debris, and is said to often generate severer wears due to the abrasive effect of the debris (Non-patent Document 1).

Measures to prevent fretting, such as (1) decrease in the relative slippage, (2) separation of the both surfaces or prevention of the direct contact of the surfaces, (3) coating of the contact surfaces such as phosphate coatings or prevention of adhesion between the surfaces by providing a lubricant or a grease have been proposed (Non-patent Document 2).

The grease which practically requires anti-fretting property, and which is well-developed and well-examined is the grease for wheel bearings for automobiles. As such a grease, the one in which an aromatic diurea is used as a thickener to make the consistency soft is reported to have extremely improved anti-fretting property as compared to the conventional lithium soap grease (Non-patent Document 1).

Thus, as a means for improving the anti-fretting property, measures have been practically taken such as changes in the type of the thickeners (the effect of the above-described item (2) by an aromatic urea coating) and making the consistency soft (improving the inflow property of the grease).

Further, a gear oil additive concentrate comprising: a base oil; an extreme pressure compound including a sulfur-containing compound; a hydrocarbyl amine compound; an alkyl phosphorothioate compound; and a compound for controlling friction, which concentrate has an improved load capacity, as well as an oil containing the same, is disclosed (Patent Document 1).

However, the aromatic diurea lacks fluidity, and for example, when employed for bearings, although a long life is attained in the case of deep groove ball bearings, it has a drawback of having short lubrication life due to insufficiency of inflow property into the lubrication unit in the case of angular ball bearings, which limits the bearings that may be used. Accordingly, the improvement by changing the thickeners causes a problem that the obtained grease lacks general versatility.

On the other hand, when the consistency of the grease is soft, there arises a problem of leakage and therefore, the grease is not applicable to the portion where leakage is problematic. Therefore, such a grease also lacks general versatility.

Patent Document 1: JP 2005-126709 A

Non-patent Document 1: YAMAMOTO Yuji et al. Tribology, published by Rikogakusha Publishing Co., Ltd., Feb. 28, 1998, pages 201-203

Non-patent Document 2: T.Endo: Eurogrease, November/December (1997), 25-40

### DISCLOSURE OF THE INVENTION

### Problems to be Solved by the Invention

Accordingly, an object of the present invention is to provide a grease composition which may decrease fretting wear.

Another object of the present invention is to provide a grease composition which has an excellent anti-fretting property and general versatility.

Still another object of the present invention is to provide machine parts which use the above-described grease composition.

### Means for Solving the Problems

The present invention attained the above-described object by adding a phosphorothioate compound and an amine compound to the grease composition comprising a thickener and a base oil. and provides the following grease composition:

1. A grease composition comprising a urea thickener, a base oil, a phosphorothioate compound and an amine compound.
2. The grease composition according to the above-described item 1, wherein the urea thickener is a diurea thickener represented by the following formula (I):

R¹—NHCONH—C₆H₄—CH₂—C₆H₄—NHCONH—R² (I)

wherein R¹ and R² are the same or different, and represent a C₆₋₃₀ alkyl group, a C₆₋₇ aryl group or a cyclohexyl group.

3. The grease composition according to the above-described item 1 or 2, wherein the phosphorothioate compound is an alkyl phosphorothioate compound.
4. The grease composition according to any one of the above-described items 1 to 3, wherein the amine compound is selected from the group consisting of aliphatic amines, alicyclic amines and aromatic amines.
5. The grease composition according to any one of the above-described items 1 to 4, wherein the base oil is a mineral oil, a synthetic oil or a mixture thereof and has a kinematic viscosity of 50 to 250 mm²/s at a temperature of 40° C.
6. A machine part, using the grease composition according to any one of the above-described items 1 to 5.
7. The machine part according to the above-described item 6, which is a rolling bearing.

### EFFECTS OF THE INVENTION

In the present invention, the anti-fretting property is thought to be improved by coating the contact surfaces with a phosphorothioate compound and an amine compound. That is, both the coatings of the contact surfaces with the phosphorothioate compound and amine compound, and the coatings of the contact surfaces such as phosphate coatings coat the surfaces by adsorbing molecules and are thought to thereby decrease fretting wear. The prevention of adhesion between the surfaces by providing lubricant and grease is thought to mean that an oil film or a thickener lies between the surfaces to prevent a direct contact thereby decreasing fretting wear.

The grease of the present invention further improves the anti-fretting property by keeping to provide lubricants and greases, as well as by using urea thickener having excellent anti-fretting property and by coating the contact surfaces with a phosphorothioate compound and an amine compound.

### EMBODIMENTS FOR CARRYING OUT THE INVENTION

Mineral oils, synthetic oils or mixtures thereof are suitable for the base oil employed in the grease composition of the present invention. Examples of the synthetic oils include varieties of synthetic oils such as: ester synthetic oils represented by diesters and polyol esters; synthetic hydrocarbon oils represented by poly-α-olefins and polybutene; ether synthetic oils represented by alkyl-diphenyl ethers and polypropylene glycols; silicone oils; and fluorinated oils. The kinematic viscosity of the base oil (at 40° C.) is preferably about 70 to 200 mm²/s.

Examples of the thickeners employed in the grease composition of the present invention include urea thickeners represented by diurea. Urea thickeners are useful because they have excellent heat-resistant property and have fewer drawbacks than other thickeners as well as they are inexpensive. Particularly preferable urea thickeners are diurea thickeners represented by the formula (I).

The content of the thickeners in the grease composition of the present invention is the one necessary for adjusting the consistency of the grease composition to about 190 to 325, which is preferably 5 to 30% by mass, and more preferably 7 to 20% by mass based on the total grease composition.

Preferable examples of phosphorothioate compounds employed in the grease composition of the present invention are represented by the following general formula. Phosphorothioate compounds employed in the present invention and the method for producing the same are described, for example in the Patent Document 1 (JP 2005-126709 A).

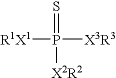

In the above formula, R¹, R² and R³ independently represent substituted or unsubstituted alkyl or a hydrogen atom, wherein at least one of R¹, R² and R³ is substituted or unsubstituted alkyl and X¹, X² and X³ independently represent an oxygen atom or a sulfur atom.

The number of carbon atoms of the alkyl groups in R¹, R² and R³ are 1 to 24, and preferably 3 to 20. Specific examples of the alkyl groups include propyl group, butyl group, hexyl group, octyl group, decyl group, dodecyl group, tetradecyl group, hexadecyl group, octadecyl group, icosyl group. Specific examples of the substituent include, for example, acyl groups, hydroxyl group, C₁₋₆ alkoxy groups, C₆₋₂₀ phenyl groups and C₆-₂₀ fatty acid ester groups.

The content of the phosphorothioate compound in the grease composition of the present invention is preferably 0.1 to 10% by mass, and more preferably 0.3 to 5% by mass based on the total mass of the grease composition.

Amine compounds employed in the grease composition of the present invention include alkylene amine compounds, primary alkyl amines, tertiary aliphatic primary amines and secondary alkyl amines, and these amine compounds may be used individually or in combination.

Specific examples of the amine compounds include N-oleyl-trimethylenediamine, N-tallow-trimethylenediamine, N-coco-trimethylenediamine and the like.

The content of the amine compound in the grease composition of the present invention is preferably 0.1 to 10% by mass, more preferably 0.3 to 5% by mass based on the total mass of the grease composition.

A commercially available mixture of the phosphorothioate compound and the amine compound may also be employed. An example of such a commercially available product includes HiTEC833 produced by Afton Chemical Corporation.

To the grease composition of the present invention, antioxidants, rust inhibitors, metal corrosion inhibitors, oiliness agents, anti-wear agents, extreme pressure agents, solid lubricants and the like may be added as required.

The grease composition of the present invention is used for a variety of machine parts which require lubrication. Examples of such machine parts include, for example, rolling bearings, ball screws, linear motion guide bearings, a wide variety of gears, cams, constant-velocity joints, journal bearings (slide bearings), pistons, screws, ropes, chains.

### EXAMPLE 1

Grease compositions were prepared by using the ingredients shown in Table 1.

As a thickener, a diurea having an aliphatic moiety and an alicyclic moiety (a compound represented by the formula (I), wherein R¹ and R² are an octadecyl group and a cyclohexyl group respectively (molar ratio: octadecyl:cyclohexyl=70:30)) was used.

All the consistencies of the greases were adjusted to 300.

A mixed oil of a mineral oil (P-type mineral oil) and a synthetic hydrocarbon oil at a ratio of 75:25 (mass ratio) was employed as a base oil.

The kinematic viscosity of this base oil (at 40° C.) was 90 mm²/s.

One percent by mass of HiTEC833 produced by Afton Chemical Corporation which is a mixture of an alkyl phosphorothioate compound and an amine compound was added as an additive for improving anti-fretting property. The following additives were employed as the other additives. The descriptions shown in parentheses are amounts of added additives by mass based on 100% by mass of the grease composition.

Antioxidant: phenol antioxidant (0.3%)
Anticorrosive: zinc naphthenate (1.0%)

Alkenyl succinic acid polyimide (0.5%)

Calcium alkylbenzenesulfonate (0.2%)

Sodium nitrite (1.42%)

Extreme pressure agent: ZnDTP (1.0%)

SP-type extreme pressure agent (0.5%)

### COMPARATIVE EXAMPLE 1

A grease composition was prepared in the same manner as in Example 1 except that HiTEC833 produced by Afton Chemical Corporation was not added.

### COMPARATIVE EXAMPLES 2 AND 3

A grease composition was prepared in the same manner as in Example 1 and Comparative Example 1 except that Li soap was employed as the thickener in place of the urea compound.

<Test Method>

The consistencies of the greases were measured in accordance with JIS K 2220.7.

The anti-fretting properties of the greases were evaluated by Fafnir friction oxidation test (based on ADTM D 4170). The test greases were applied to two pairs of the following test thrust bearings, and the bearings were subjected to a prescribed vibratory motion to determine an abrasion loss (weight loss by fretting abrasion).

### [Test Conditions]

Bearings: ANDREWS W 5/8

Load: 2450N (550 lbf) (surface pressure: 1861 MPa)

Angle of oscillation 0.21 rad (12°)

Oscillation cycle: 25 Hz

Time: 22 h

Temperature: −10° C.

Amount of grease enclosed: 1.0 g per pair of bearings

Abrasion loss: loss of the race mass per pair of bearings ((total loss of the test bearing race)/2)

The results are shown in Table 1.

TABLE I

| | | Sample | | | |
|---|---|---|---|---|---|
| | | | Comparative | Comparative | Comparative |
| | | Example 1 | Example 1 | Example 2 | Example 3 |
| Thickener | | aliphatic + | aliphatic + | Li soap | Li soap |
| | | alicyclic diurea | alicyclic diurea | | |
| Base | Mineral oil | 75 | 75 | 75 | 75 |
| oil | Synthetic | 25 | 25 | 25 | 25 |
| ratio | hydrocarbon oil | | | | |

| | | | | |
|---|---|---|---|---|
| Base oil kinematic viscosity | 90 | 90 | 90 | 90 |
| (40° C.) [mm²/s] | | | | |
| Anti-fretting additive * [mass %] | 1.0 | 0.0 | 1.0 | 0.0 |
| Consistency | 300 | 300 | 300 | 300 |
| Anti-fretting property | 6.5 | 13.4 | 18.3 | 21.0 |
| Abrasion loss [mg] | | | | |

* HiTEC833 produced by Afton Chemical Corporation

In Example 1 in which an alkyl phosphorothioate compound and an amine compound were added as anti-fretting additives, the abrasion loss was 6.5 mg, which was about half the abrasion loss 13.4 mg in Comparative Example 1 in which an anti-fretting additive was not included. Thus, a marked improvement was observed.

In Comparative Examples 2 and 3 in which Li soap was used as a thickener, it was found that the addition of an anti-fretting additive had a little effect of decreasing abrasion loss.

1. A grease composition comprising a urea thickener, a base oil, a phosphorothioate compound and an amine compound.

2. The grease composition according to claim 1, wherein the urea thickener is a diurea thickener represented by the following formula (I):
R¹—NHCONH—C₆H₄—CH₂—C₆H₄—NHCONH—R² (I)
wherein R¹ and R² are the same or different, and represent a C₆₋₃₀ alkyl group, a C₆₋₇ aryl group or a cyclohexyl group.

3. The grease composition according to claim 1, wherein the phosphorothioate compound is an alkyl phosphorothioate compound.

4. The grease composition according to claim 1, wherein the amine compound is selected from the group consisting of aliphatic amines, alicyclic amines and aromatic amines.

5. The grease composition according to claim 1, wherein the base oil is a mineral oil, a synthetic oil or a mixture thereof and has a kinematic viscosity of 50 to 250 mm²/s at a temperature of 40° C.

6. A machine part, using the grease composition according to claim 1.

7. The machine part according to claim 6, which is a rolling bearing.
